(19) United States
(12) Patent Application Publication
(10) Pub. No.: US 2025/0313246 A1
(43) Pub. Date: Oct. 9, 2025

(54) WHEELED HAND TRUCK FOR MOVING ITEMS

(71) Applicant: Joshua Stuart Mosher, Elk Rapids, MI (US)

(72) Inventor: Joshua Stuart Mosher, Elk Rapids, MI (US)

(21) Appl. No.: 19/057,028

(22) Filed: Feb. 19, 2025

Related U.S. Application Data
(60) Provisional application No. 63/575,172, filed on Apr. 5, 2024.

(51) Int. Cl. B62B 1/06; B62B 1/04; E01C 19/52

(52) U.S. Cl. CPC B62B 1/06; B62B 1/04; E01C 19/528

(57) ABSTRACT

A wheeled hand truck for transporting objects including an elongated handle and a pair of wheels connected by an axle with a bearing supported outer sleeve. Brackets connect the handle to the outer sleeve, a width extending support extending between the brackets. A forward facing support secures to the handle and, upon rotation, is adapted to engage a rear edge of the object. A forwardly extending arm is pivotally supported upon a crosswise support, with a head portion mounted to a distal end of the arm to engage a forward edge of the object. Forward pivoting of the handle causes the head portion to displace beyond a forward edge of the object, with subsequent rearward pivoting causing the head portion to engage the object, with continued backwards tilting of the handle lifting the object for transport.

### CROSS REFERENCE TO RELATED APPLICATIONS

The present application claims the priority of U.S. Ser. No. 63/575,172 filed Apr. 5, 2024.

### FIELD OF THE INVENTION

The present invention relates generally to wheeled hand truck or dolly assemblies. More specifically, the present invention teaches a hand truck incorporating a pivotal handle with rotating lower head and adjustable extending arm support for gripping, pivotally lifting and transporting opposite edge locations of heavy items, including irregular shaped paver stones or flagstones, utilizing the mechanical advantage provided by the present assembly.

### BACKGROUND OF THE INVENTION

The prior art is documented with lifting mechanism which utilize such as suction or pinch techniques, these typically having only a single flat point of contact which cannot securely grab irregularly shaped items. These mechanisms are further typically limited to grasping and moving items having even or straight edges.

US 2023/0002163A1, to Oliphant, teaches a lifting apparatus having a handle and a scissor grip. The scissor grip is actuated by pushing the handle downward or by lifting it upward. Each end of the scissor grip comprises a bracket for coupling to opposing edges of an object to be lifted. As the handle is raised, the scissor grip actuates, squeezing and holding the object between the brackets. Alternatively, in some embodiments, as the handle is raised, the scissor grip may actuate, expanding and exerting outward force and thus holding an object from an interior. A user may then easily transport the object to the desired location, place the object without bending, and may release the object from the scissor grip by pressing downward on the handle and pivoting it to release at least one bracket from the side of the object.

A further example from the patent art is depicted in US 2021/0380344, to Carroccia, which teaches a masonry transport assembly for carrying a paver, tile, or quarried stone. The masonry transport assembly generally includes a hinged clamping member including a first arm having a first length, a second arm having a second length. A hinge pivotally connects the first arm and the second arm, a terminal gripping angled end extending from each of the first and second arms and on ends thereof opposite the hinge. A release mechanism is secured to at least one of the first arm or the second arm. A mounting eyelet is connected to at least one of the first arm or the second arm so that it is operatively arranged to receive and connect the support member.

Finally, U.S. Pat. No. 3,885,688 to Larsen teaches a device for laying of flagstones forming a double-armed lever structure carried by wheels forming the tilting axis, the one arm carrying a pair of tongs for carrying a flagstone in horizontal position and releasing the same by hitting a firm object, the other arm being provided with handles for operating the device. The lever structure comprising a beam carries the pair of tongs and pivotally connects to a main frame carrying the supporting wheels and handles, spring means for lifting the beam when unloaded, and hydraulic means for manually controlling the movements of the beam.

### SUMMARY OF THE INVENTION

The present invention discloses a wheeled hand truck for allowing a single person to grip, rotate/lift, transport and set/release heavy objects such as paver stones and flagstones, and which would otherwise require two or more individual with greater effort in order to move with increased risk of injury. In operation, the hand truck provides for gripping, pivotally lifting and transporting opposite edge locations of heavy items, including irregular shaped paver stones and flagstones, utilizing the mechanical advantage provided by the present assembly.

A main handle is provided which includes a frame defined by a pair of length extending members rotatably supported upon a pair of wheels and having a movable rear gripping support, this provided in a first embodiment as a width elongated bottom rail which is adapted to contact an opposing rear opposing edge of the object to be lifted. In an alternate configuration, the bottom rail can be substituted by a flattened plate or pair of plates affixed along lower ends of the elongated arms, enabling the assembly to support taller retaining blacks as well as pavers and flagstones.

The pair of wheels include a width extending axle surrounded by a bearing supported outer sleeve, to which in turn is secured lower brackets of the handle including a width extending support for permitting the handle to be pivotal relative to the wheels. An extending and length adjustable arm is supported in a limited pivotal fashion atop the lower width extending support of the handle located between the wheels and can include, in a first configuration, a flat head portion mounted at a distal end of the arm for gripping an opposing forward smooth extending edge of the object.

In a further configuration, a triangular shaped pivotal/rotating lower head is instead secured to the extending arm support, which provides two points of contact for gripping and lifting a forward distal or opposing irregular edge of the object. The triangular shaped head can also incorporate low-tension springs that assist in keeping the head perpendicular to the lever arm, and until the pair of spaced apart pins contact the flagstone and adjust against the flagstone or other object in order to establish a solid grip. Additionally, the adjustability of the arm length allows for different sizes of pavers/flagstone to be lifted grasped and lifted.

The mechanics behind the rotating and lifting the heavy object (e.g. paver or flagstone) initially include aligning the rear or proximal edge of the object against the rear support (bottom rail or flattened plates) of the handle. At this point, forward pivoting the handle causes the extending lever arm (which may have been previously length adjusted) to displace in a forward direction, allowing the mounted head portion of the arm to reach beyond the object being picked up.

The handle is subsequently tilted back toward the user, decreasing the distance between the rear gripping support and forward gripping head situated at the end of the lever arm, resulting in the pinching of the object. As gravity pulls the object to be lifted toward the ground the pinching force increases, causing the paver or other object to be securely supported as it is upwardly pivoted, again utilizing the mechanical advantage provided by the assembly and permitting it to be moved by the single individual. Once the object reaches the desired location, the handle is tilted forwardly of the user, causing the object to descend towards the ground, upon which a release pedal situated on a back end of the lever arm is depressed, causing the arm to pivot about its limited range defined by a fulcrum defined with the lower handle, resulting in the inwardly facing distal gripping head separating and release from the paver or other object, thereby allowing it to be set in place.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective view of the wheeled hand truck or dolly according to a non-limited embodiment of the present invention and including a wheeled and pivotally supported handle with lower rear support defined by a gripping bottom rail, along with a forward arm supported gripping head for grasping and upwardly rotating an irregular shaped object (depicted in phantom), the forward supported gripping head including a triangular shaped attachment secured to the forward arm;

FIG. 2 is a rotated and rear perspective view of the hand truck depicted in FIG. 1 and further showing the alternate forward arm attachment substituting for the triangular shaped attachment of FIG. 1 and including a flat portion having a first side welded or otherwise affixed to an underside end of forward arm, with an downwardly angled second side adapted to contact ae distal edge of the object to be lifted, as well as showing a limited pivotal/fulcrum support established between a rear intermediate location of the arm and a crosswise support of the lower handle;

FIG. 3 is a further rotated and enlarged rear perspective view of the present invention showing the triangular shaped head attachment of FIG. 1 and better illustrating the lower portion of the handle including the width extending axle surrounding by a bearing supported outer sleeve, to which in turn is secured lower brackets of the handle including a width extending support for permitting the handle to be pivotal relative to the wheels, and in addition to the limited pivotal upward release of the elongated arm head attachment;

FIG. 4 is a forward rotated view of the lower hand truck assembly illustrating the pivotal rotation of the handle and concurrent fore and aft displacement of the bottom rear support rail towards and away from the forward arm supported head attachment for gripping and lifting the item;

FIG. 5 is a perspective illustration of the wheeled hand truck as shown in FIG. 2 and again including a wheeled and pivotally supported handle with lower rear gripping bottom rail and forward arm supported planar gripping head for grasping and upwardly rotating any regular or irregular shaped object;

FIG. 6 is an illustration similar to FIG. 4 arrayed in an opposite forward perspective and showing the pivotal rotation of the handle and concurrent fore and aft displacement of the bottom rail towards and away from the forward arm supported flat head attachment for gripping and lifting the item therebetween;

FIG. 7 is a perspective view of the wheeled hand truck or dolly according to a further non-limited embodiment of the present invention and including a wheeled and pivotally supported handle with lower rear support plate substituting for the width extending angled bottom rail of FIG. 1, and again including a forward arm supported gripping head for grasping and upwardly rotating any regular or irregular shaped object (depicted in phantom) including taller items and further depicting the triangular shaped attachment secured to the forward arm;

FIG. 8 is a rotated and rear perspective view of the hand truck depicted in FIG. 7 and further showing the alternate forward arm attachment substituting for the triangular shaped attachment of FIG. 1, again including the flat portion having a first side welded or otherwise affixed to an underside end of forward arm, with an downwardly angled second side adapted to contact a distal edge of the object to be lifted, as well as showing a limited pivotal/fulcrum support established between a rear intermediate location of the arm and a crosswise support of the lower handle;

FIG. 9 is a forward rotated view of the lower hand truck assembly of FIG. 7 illustrating the pivotal rotation of the handle and concurrent fore and aft displacement of the lower plates towards and away from the forward arm supported head attachment for gripping and lifting the item;

FIG. 10 is a perspective illustration of the wheeled hand truck as shown in FIG. 8 and again including a wheeled and pivotally supported handle with lower rear gripping bottom rail and forward arm supported planar gripping head for grasping and upwardly rotating any regular or irregular shaped object; and

FIG. 11 is an illustration similar to FIG. 9 arrayed in an opposite forward perspective and showing the pivotal rotation of the handle and concurrent fore and aft displacement of the bottom support plates towards and away from the forward arm supported flat head attachment for gripping and lifting the item.

### DETAILED DESCRIPTION OF THE PREFERRED EMBODIMENTS

With reference to the attached illustrations, the present invention discloses a trolley or dolly mechanism incorporating a combination of a pivotal handle and an adjustable extending arm support for gripping, pivotally lifting and transporting heavy items utilizing the mechanical advantage provided by the present assembly.

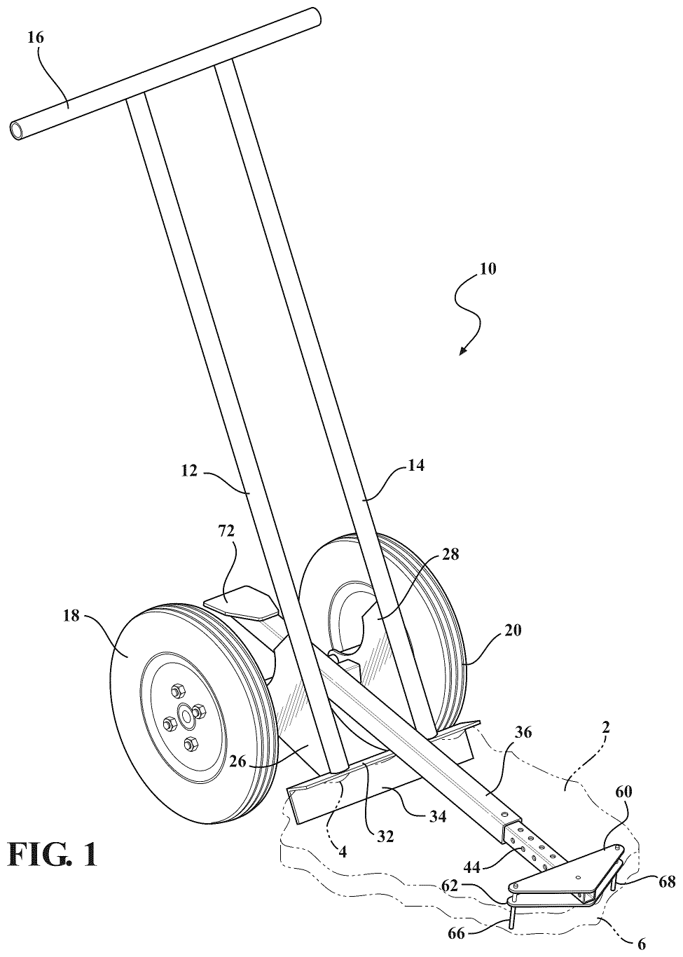

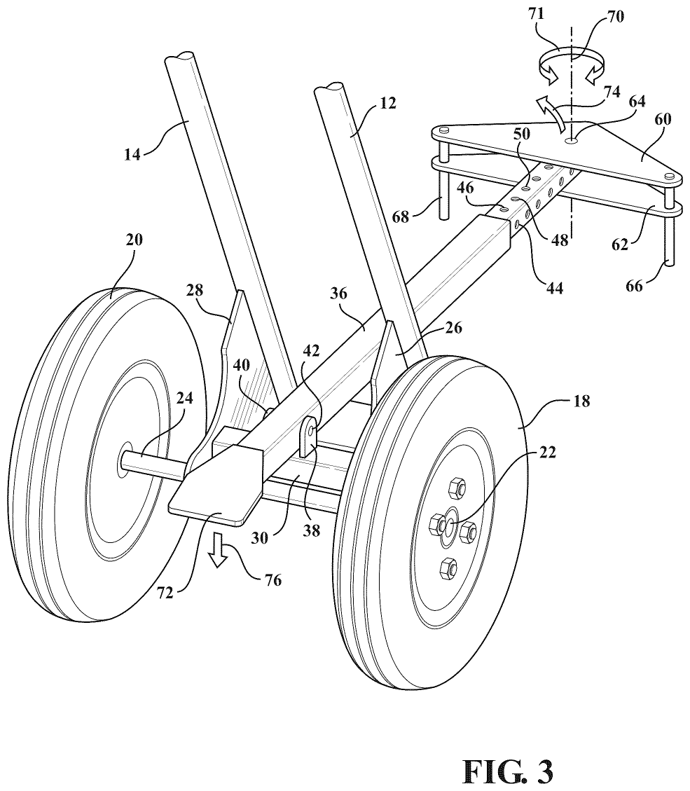

FIG. 1 is a perspective view of the wheeled hand truck, generally at 10, according to a non-limited embodiment of the present invention and including a wheeled and pivotally supported handle which, in the illustrated embodiment, includes first 12 and second 14 elongated members with an upper interconnecting hand grasping member 16. A pair of wheels 18 and 20 are connected by a width extending axle 22 surrounded by a bearing supported outer sleeve 24 (see as best shown in rotated enlarged view of FIG. 3).

As shown in FIG. 1, the components of the hand truck 10 are constructed from any suitable material and are configured to grasp and lift a heavy object (see as shown in phantom at 2) having a first proximal edge 4 and a second opposite distal edge 6. Without limitation the object can include a paver stone or flagstone however, and as will be described, can also include any other regular or irregular shaped object or item presenting first and second gripping surfaces adaptable to being pinched or gripped by the present assembly for pivotally lifting, transporting and re-setting upon a ground location.

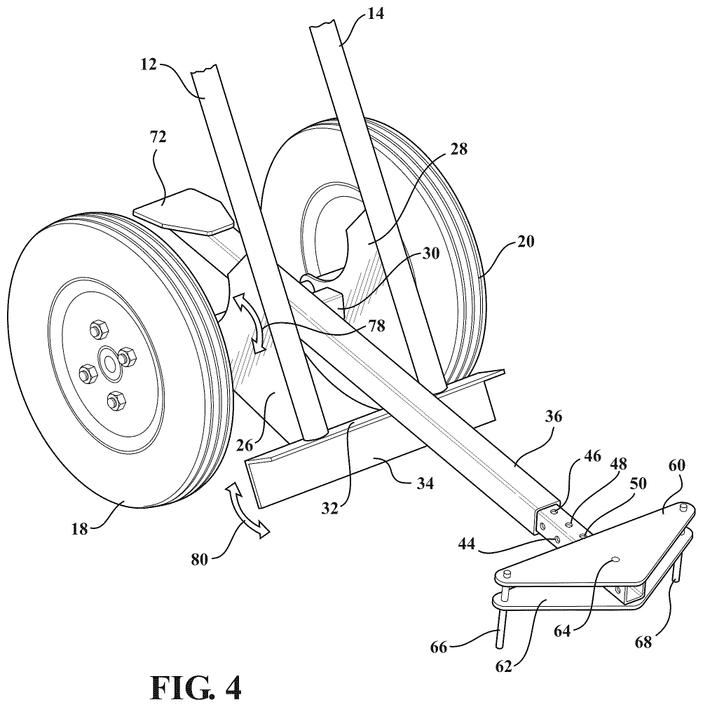

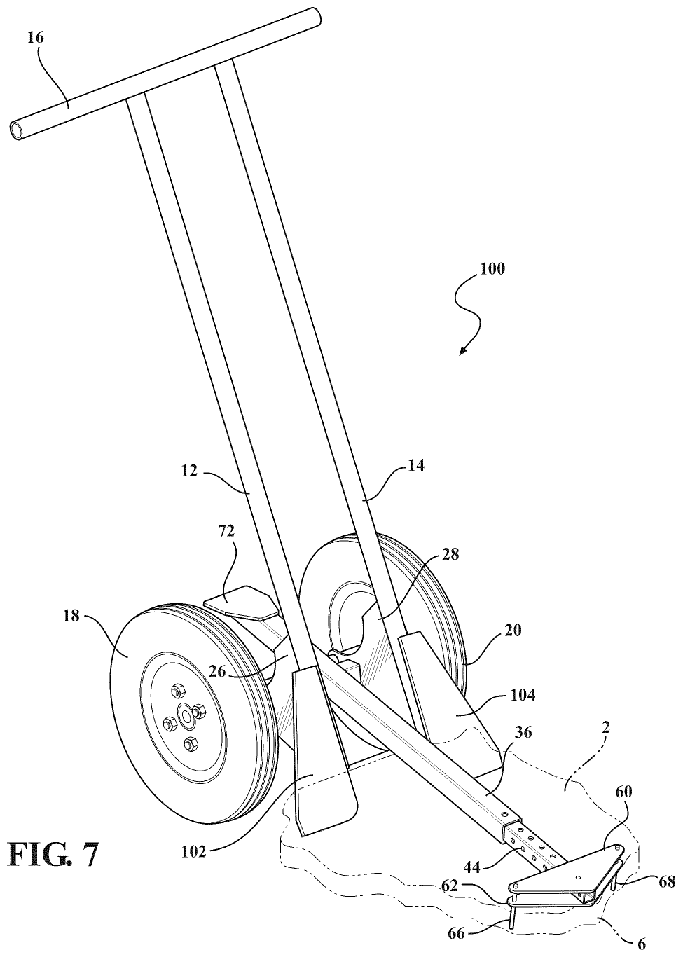

A pair of brackets 26 and 28 are integrated into lower ends of the elongated arms 12 and 14 and extend to the outer support sleeve 24. A crosswise support 30 extends between the brackets 26/28. As best shown in FIGS. 1 and 4, a forward facing support surface defined at the lower ends of the elongated members 12/14 is depicted and, according to a first embodiment, is provided as a width elongated bottom rail (as compared to the support plates 102/104 subsequently depicted in FIGS. 7 et seq.).

The bottom rail of FIG. 1 can exhibit an “L” shape in cross section and includes a first side 32 which is secured or integrated to a forward end of the lower brackets 26/28 and, optionally and as shown, also connected to lower ends of the elongated members 12/14. The width extending bottom rail further includes a second angled side (or lip) 34, typically arrayed at a perpendicular relative to the first side 32, and such that, upon rotation of the handle, such that the angled sides 32/34 of the width extending rail are adapted to displace into engagement with the opposing rear edge 4 of the object 2.

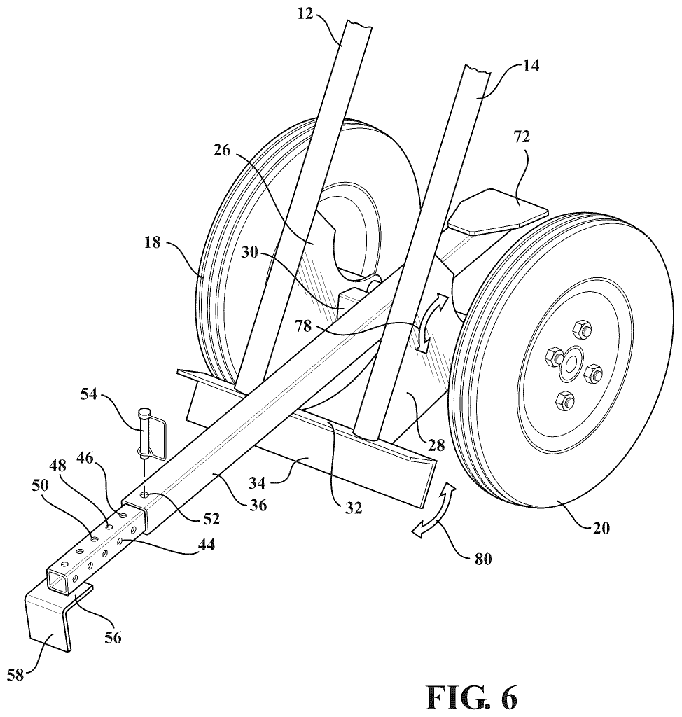

A length adjustable and forwardly extending arm is provided and includes an outer tubular portion 36 pivotally supported upon the width extending support 30 (see as best shown in FIG. 3 which depicts the tubular portion 36 pivotally supported in a limited range at a rear intermediate location of the tubular portion 36 between a pair of ears 38/40 welded or otherwise secured atop the width extending support 30, a pin or bolt 42 seating through aligning apertures in the ears 38/40 and the outer tubular portion 36 for establishing the limited pivotal support. An inner tubular portion 44 is telescopically received in the outer tubular portion 36, with the inner portion 44 including a plurality of spaced apart apertures 46, 48, 50, et seq. As further shown in FIG. 6, a further pair of aligning apertures 52 can be formed in the outer tubular portion 36 in proximity to its forward end and, upon aligning with a selected pair of aligning apertures configured in the inner telescoping portion 44, receiving a cotter pin 54 or the like.

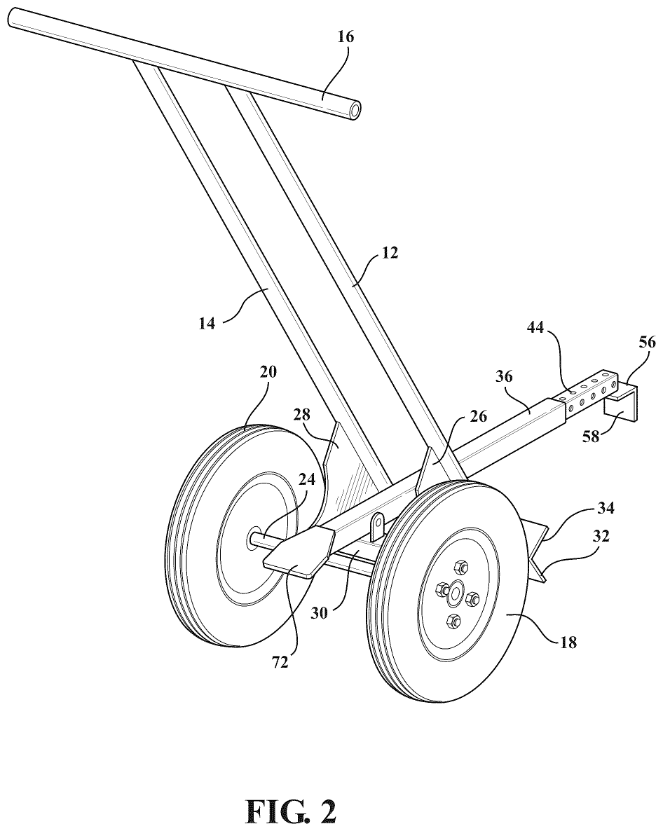

A head portion is mounted to a distal end of the inner telescoping portion 44 and, in the variant of FIGS. 2, 5 and 6, includes a flat portion having an “L” shape similar to the width extending rail 32/34, the flat portion including a first side 56 welded or otherwise affixed to an underside end of the inner telescoping member 44, with an downwardly angled second side 58 adapted to contact the distal edge 6 of the object 2 to be lifted (such including a level or straight edge of the object such as typically associated with a rectangular paver stone, block or the like however which can also be utilized with an irregular shaped object).

In a further configuration (FIGS. 1, 3 and 4), the “L” shaped head portion is substituted by a triangular shaped pivotal/rotating lower head which includes a pair of upper 60 and lower 62 plates which are pivotally mounted to the forward end of the inner tubular member as depicted by a pin (not shown) which can seat through apertures in the plates (see aperture 64 for plate 60) and an outermost proximate aperture (see again 46, 48, 50, et seq.) defined in the inner telescoping portion 44. The triangular shaped head portion provides two points of contact (see pins 66 and 68) for gripping and lifting a forward distal or opposing irregular edge (again at 6 in FIG. 1) of the object 2. The triangular shaped head can also incorporate low-tension springs, not shown but which can include any of leaf, coil or torsional springs integrated in the pivotal connection defined by axis 70 in FIG. 3, that assist in keeping the head (again defined by its plates 60/62) perpendicular to the inner telescoping lever arm 44, and until the pair of spaced apart pins 66/68 contact the object 2 in order to establish a solid grip. Additionally, and as previously described, the adjustability of the arm length allows for different sizes of pavers/flagstone to be lifted grasped and lifted.

A release pedal 72 is situated on a back or proximal end of the outer tubular lever arm 36 and which, upon being depressed, causes the arm to pivot about a fulcrum (see at 74 in FIG. 3) defined with the width extending support 30, this resulting in either configuration of the head portion separating and releasing from the object. Prior to engaging the release pedal 72, the pinching effect of the forward head portion is released via forward pivoting of the elongated handle.

In operation, the pivotally supported and lower width extending support plate (32/34) is aligned into abutment with the rear edge 4 of the object 2. Forward pivoting of the handle then causes the arm (36/44) to displace beyond the forward edge 6 of the object, with the elongated handle subsequently being tilted backwards, decreasing the distance between the rear gripping bottom rail 32/34 and the gripping head (either flat or triangular). This further results in the head portion being adapted to engage the forward edge of the object (along a single point associated with the flat head version (56/58) or the two point contact for an irregular edge (established by the spaced pins 66/68 of the triangular variant) which, in combination with the bottom rail, allows continued backwards tilting of the handle to lift the object 2.

The handle is subsequently tilted back toward the user, decreasing the distance between the rear gripping bottom rail 32/34 and forward gripping head situated at the end of the lever arm, resulting in the pinching of the object. As gravity pulls the object to be lifted toward the ground the pinching force increases, causing the paver or other object to be securely supported as it is upwardly pivoted, again utilizing the mechanical advantage provided by the assembly and permitting it to be moved by the single individual. Once the object reaches the desired location, the handle is tilted forwardly of the user, causing the object to descend towards the ground, upon which a release pedal situated on a back end of the lever arm is depressed, causing the arm to pivot about its limited range defined by a fulcrum defined with the lower handle, resulting in the inwardly facing distal gripping head to separate and release from the paver or other object, thereby allowing it to be set in place.

Addressing the remaining views, FIG. 2 provides is a rotated and rear perspective view of the hand truck depicted in FIG. 1 and further showing the alternate forward arm attachment substituting for the triangular shaped attachment of FIG. 1 and including a flat portion having a first side welded or otherwise affixed to an underside end of forward arm, with an downwardly angled second side adapted to contact ae distal edge of the object to be lifted, as well as showing a limited pivotal/fulcrum support established between a rear intermediate location of the arm and a crosswise support of the lower handle;

FIG. 3 is a further rotated and enlarged rear perspective view of the present invention showing the triangular shaped head attachment previously described and better illustrating the lower portion of the handle including the width extending axle 22 surrounding by the bearing supported outer sleeve 24, to which in turn is secured the lower brackets 26/28 of the handle elongated members 12/14. Again included is the width extending support 30 for permitting the elongated handle to be pivotal relative to the wheels 18/20, and in addition to the limited pivotal upward release of the elongated arm head attachment (see downward direction arrow 76 representing the limited range of pivotal motion of the release pedal sufficient for detaching the head portion from the forward edge 6 of the object 2). Also shown in FIG. 3 is the rotational axial spring loaded support of the triangular shaped head portion (about axis 70) and as reflected by additional bi-directional arrow 71 depicting the spring loaded compensating effect of the triangular shaped head portion responding to irregular contact locations with the forward edge 6 of the object 2 (see again FIG. 1).

FIG. 4 is a forward rotated view of the lower hand truck assembly illustrating the pivotal rotation of the handle and concurrent fore and aft displacement of the bottom rail (32/34) towards and away from the forward arm supported head attachment for gripping and lifting the item 2. As understood the arrangement of the lower rail is such that it non-concentric relative to the bearing supported outer sleeve 24 and so that pivoting of the handle, brackets and rail (see rotational directional arrow 78) results in a non-concentric or eccentric forward angular pivoting of the lower rail 32/34 (further depicted by arrow 80) which establishes the pinching effect of the object 2 between the rear rail and forward head portion.

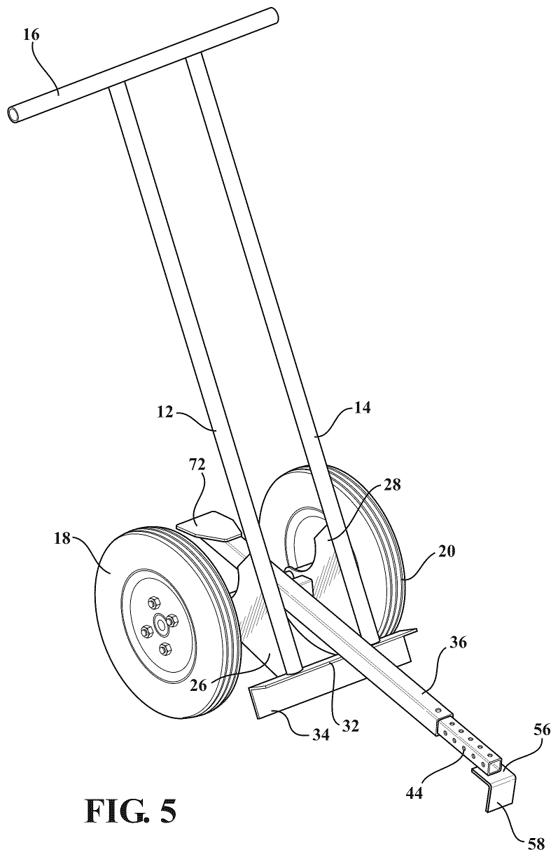

FIG. 5 is a perspective illustration of the wheeled hand truck or trolley as largely described in FIG. 2 and again including the wheeled and pivotally supported handle with lower rear gripping bottom rail and forward arm supported planar gripping head for grasping and upwardly rotating a regular shaped object. FIG. 6 is an illustration similar to FIG. 4 arrayed in an opposite forward perspective and showing the pivotal rotation of the handle and concurrent fore and aft displacement of the bottom rail towards and away from the forward arm supported flat head attachment for gripping and lifting the item.

Proceeding to FIG. 7, a perspective view is generally shown at 100, of the wheeled hand truck or dolly according to a further non-limited embodiment of the present invention. For purposes of ease of explanation, identical reference numerals are used for common features described for the hand truck 10 of the first embodiment, and which again includes a wheeled and pivotally supported handle as previously described.

Comparing to the embodiment 10 of FIG. 1, the rear engaging support provided by the width extending rail 32/34 of the first embodiment is substituted in FIG. 7 by a pair of flattened support plates, see at 102 and 104. The bottom plates 102/104 can be welded or otherwise secured to the lower ends of the elongated members 12/14 and, in operation, permit the grasping and lifting of taller objects than may otherwise be possible with the rail 32/34 configuration. Without limitation, and in addition to being welded to the lower ends of the elongated members 12/14, the flattened front facing plates 102/104 can also be interconnected in order to form a single overall plate and in order to provide additional strength and rigidity.

As in the initial embodiment, the forward arm supported gripping head for grasping and upwardly rotating an irregular shaped object (again depicted in phantom at 2) includes the ability to grip taller items, with the triangular shaped attachment (see upper 60 and lower 62 plates) being secured to the forward arm (see again outer tubular portion 36 with inner telescoping tubular portion 44).

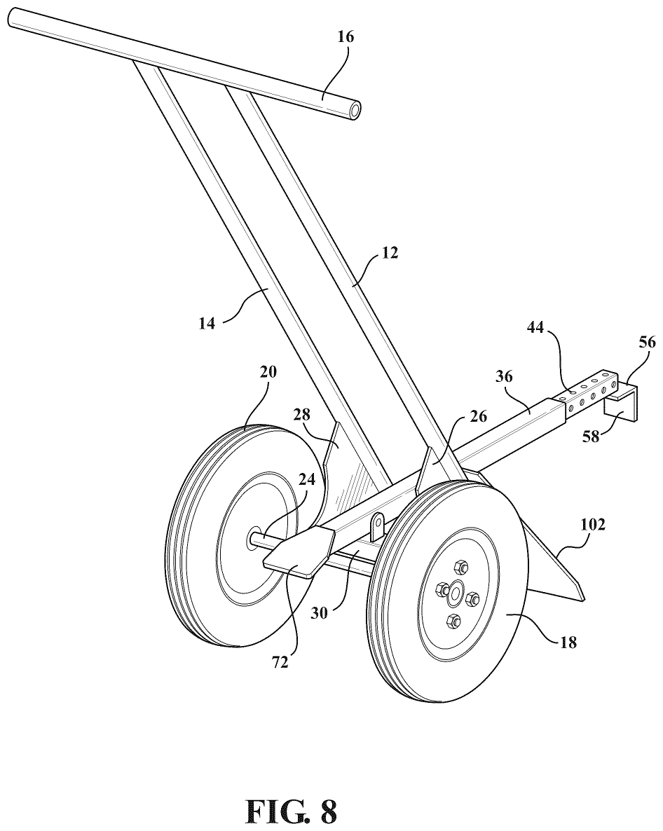

FIG. 8 presents a rotated and rear perspective view of the hand truck depicted in FIG. 7 and further showing the alternate forward arm attachment substituting for the triangular shaped attachment of FIG. 1 and including the flat portion having the first side 56 welded or otherwise affixed to an underside end of forward telescopically supported arm 44, with the downwardly angled second side 58 adapted to contact the distal edge 6 of the object 2 to be lifted, as well as showing a limited pivotal/fulcrum support established between a rear intermediate location of the arm 36 and a crosswise support 30.

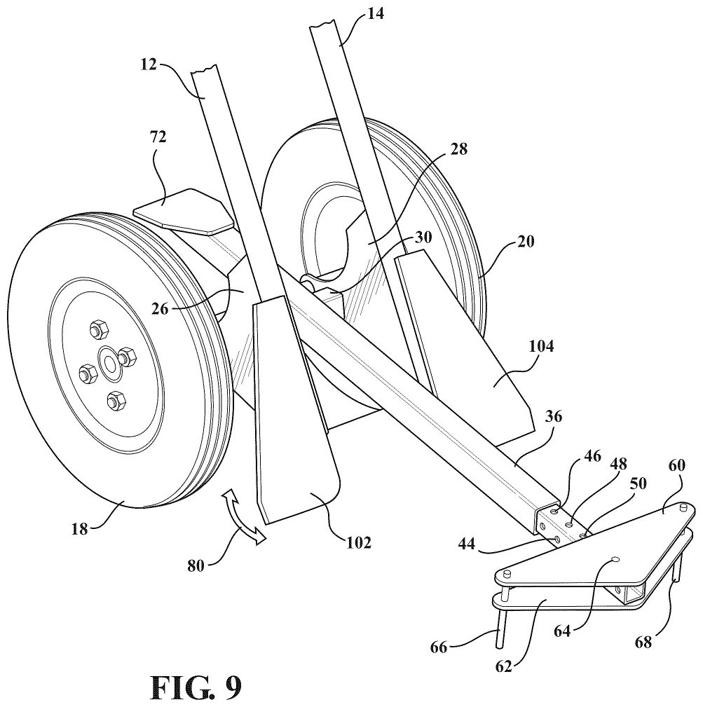

FIG. 9 is a forward rotated view of the lower hand truck assembly of FIG. 7 illustrating the pivotal rotation of the handle (arms 12/14) and concurrent fore and aft displacement of the bottom support plates 102/104 towards and away from the forward arm supported head attachment (triangular shaped with upper 60 and lower 62 plates) for gripping and lifting the item 2.

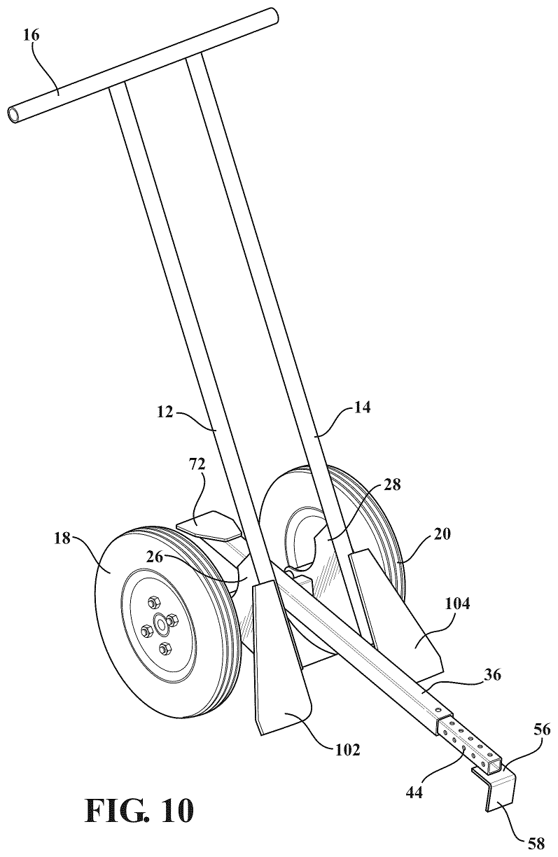

FIG. 10 is a perspective illustration of the wheeled hand truck as shown in FIG. 8 and again including a wheeled and pivotally supported handle defined by the elongated arms 12/14 with lower rear supporting plates 102/104 and forward arm supported planar gripping head (56/58) for grasping and upwardly rotating a regular or irregular shaped object 2.

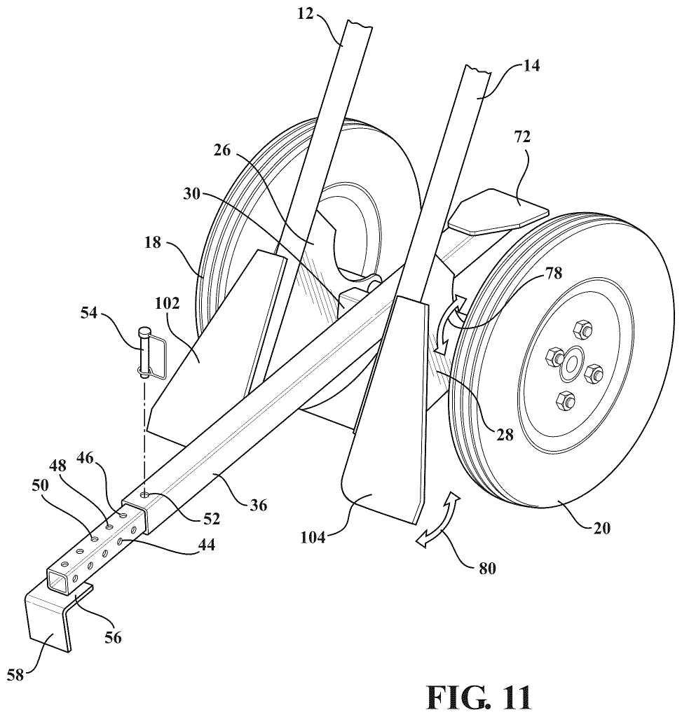

Finally, FIG. 11 is an illustration similar to FIG. 9 arrayed in an opposite forward perspective and showing the pivotal rotation of the handle and concurrent fore and aft displacement of the bottom rear support plates 102/104 towards and away from the forward arm (36/44) supported flat head attachment for gripping and lifting the object or item 2. As previously described, and beyond that shown, the present invention can be utilized for lifting and moving other items not limited to such as concrete wall blocks or steps.

Having described my invention, other and additional preferred embodiments will become apparent to those skilled in the art to which it pertains, and without deviating from the scope of the appended claims. The detailed description and drawings are further understood to be supportive of the disclosure, the scope of which being defined by the claims. While some of the best modes and other embodiments for carrying out the claimed teachings have been described in detail, various alternative designs and embodiments exist for practicing the disclosure defined in the appended claims.

The foregoing disclosure is further understood as not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosure. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application. Additionally, any signal hatches in the drawings/figures should be considered only as exemplary, and not limiting, unless otherwise specifically specified.

1. A wheeled hand truck for transporting an object, comprising:
an elongated handle including a pair of length extending members with an upper interconnecting member;
a pair of wheels connected by a width extending axle rotatably supported within an outer sleeve;
a pair of brackets integrated into lower ends of said elongated arms and securing to said outer sleeve;
a crosswise support extending between said brackets;
upon rotation of said handle, a forward facing support defined at lower ends of said elongated members being adapted to displace into engagement with an opposing rear edge of the object;
a forwardly extending arm being pivotally supported at an intermediate location upon said crosswise support, a head portion mounted to a distal end of said arm; and
forward pivoting of said handle causing said head portion to displace beyond a forward edge of the object, with subsequent rearward pivoting causing said head portion to engage the forward edge of the object in combination with said forward facing support engaging the rear edge, with continued backwards tilting of said handle about said axle lifting of the object for transport.

2. The wheeled hand truck of claim 1, said head portion further comprising a flat portion mounted at a distal end of the arm adapted for gripping the forward edge of the object.

3. The wheeled hand truck of claim 1, said head portion further comprising a triangular shaped portion having a pair of spaced apart pins for gripping and lifting the forward edge of the object having an irregular profile.

4. The wheeled hand truck of claim 3, further comprising low-tension springs permitting said triangular shaped portion to rotate about a vertical axis formed with said arm to assist in keeping said head portion perpendicular to said arm until said pair of spaced apart pins contact the object.

5. The wheeled hand truck of claim 1, further comprising a release pedal situated at a proximal end of said forwardly extending arm which, upon being depressed, causing said arm to pivot about a fulcrum defined with said crosswise support, resulting in said head portion separating and releasing from the object.

6. The wheeled hand truck of claim 1, said forwardly extending arm further comprising an outer tubular portion pivotally supported upon said crosswise support, an inner tubular portion telescopically received in said outer tubular portion for securing said head portion.

7. The wheeled hand truck of claim 6, further comprising a pair of ears welded atop said crosswise support, a pin or bolt seating through aligning apertures in said ears and said outer tubular portion for establishing said pivotal support.

8. The wheeled hand truck of claim 6, said the inner tubular portion further comprising a plurality of spaced apart apertures, a further pair of aligning apertures being formed in said outer tubular portion in proximity to its forward end so that, upon aligning with selected aligning apertures configured in said inner telescoping portion, receiving a pin for establishing an fixed overall distance.

9. The wheeled hand truck of claim 1, said forward facing support further comprising a width extending bottom rail having an “L” shape in cross section and including a first side integrated into a forward end of said brackets and a second angled side arrayed at a perpendicular relative to said first side.

10. The wheeled hand truck of claim 1, said forward facing support further comprising support plates welded or otherwise secured to the lower ends of said elongated members.

11. A wheeled hand truck for transporting an object, comprising:
an elongated handle pivotally supported upon a pair of wheels;
a crosswise support extending between said wheels and securing to spaced apart brackets incorporated into said handle;
upon rotation of said handle, a forward facing support disposed on said handle being adapted to displace into engagement with a rear edge of the object;
a forwardly extending arm being pivotally supported upon said crosswise support, a head portion mounted to a distal end of said arm; and
forward pivoting of said handle causing said head portion to displace beyond a forward edge of the object, with subsequent rearward pivoting causing said head portion to engage the forward edge of the object in combination with said forward facing support engaging the rear edge, with continued backwards tilting of said handle about said axle lifting of the object for transport.

12. The wheeled hand truck of claim 11, said head portion further comprising a flat portion mounted at a distal end of the arm adapted for gripping the forward edge of the object.

13. The wheeled hand truck of claim 11, said head portion further comprising a triangular shaped portion having a pair of spaced apart pins for gripping and lifting the forward edge of the object having an irregular profile.

14. The wheeled hand truck of claim 13, further comprising low-tension springs permitting said triangular shaped portion to rotate about a vertical axis formed with said arm to assist in keeping said head portion perpendicular to said arm until said pair of spaced apart pins contact the object.

15. The wheeled hand truck of claim 11, further comprising a release pedal situated at a proximal end of said forwardly extending arm which, upon being depressed, causing said arm to pivot about a fulcrum defined with said crosswise support, resulting in said head portion separating and releasing from the object.

16. The wheeled hand truck of claim 11, said forwardly extending arm further comprising an outer tubular portion pivotally supported upon said crosswise support, an inner tubular portion telescopically received in said outer tubular portion for securing said head portion.

17. The wheeled hand truck of claim 16, further comprising a pair of ears welded atop said crosswise support, a pin or bolt seating through aligning apertures in said ears and said outer tubular portion for establishing said pivotal support.

18. The wheeled hand truck of claim 16, said the inner tubular portion further comprising a plurality of spaced apart apertures, a further pair of aligning apertures being formed in said outer tubular portion in proximity to its forward end so that, upon aligning with selected aligning apertures configured in said inner telescoping portion, receiving a pin for establishing an fixed overall distance.

19. The wheeled hand truck of claim 11, said forward facing support further comprising a width extending bottom rail having an “L” shape in cross section and including a first side integrated into a forward end of said brackets and a second angled side arrayed at a perpendicular relative to said first side.

20. The wheeled hand truck of claim 11, said forward facing support further comprising support plates welded or otherwise secured to the lower ends of said elongated members.
